(19) United States
(12) Patent Application Publication
(10) Pub. No.: US 2007/0187516 A1
(43) Pub. Date: Aug. 16, 2007

(54) SCENTED AUTHORIZATION CARD AND METHOD OF MANUFACTURE

(75) Inventors: Adam Bell, Short Hills, NJ (US); James Blumenfeld, Lincroft, NJ (US)

Correspondence Address: DARBY & DARBY P.C., P.O. BOX 770, Church Street Station, New York, NY, 10008-0770, US

(73) Assignee: Rotuba Extruders, Inc., Linden, NJ (US)

(21) Appl. No.: 11/733,721

(22) Filed: Apr. 10, 2007

Related U.S. Application Data
(63) Continuation-in-part of application No. 11/440,251, filed on May 23, 2006.
Application No. 11/440,251 is a continuation-in-part of application No. 11/307,758, filed on Feb. 21, 2006.
(60) Provisional application No. 60/692,644, filed on Jun. 20, 2005.
(60) Provisional application No. 60/705,807, filed on Aug. 4, 2005.
(60) Provisional application No. 60/739,304, filed on Nov. 23, 2005.

(51) Int. Cl. G06K 19/02

(52) U.S. Cl. 235/488

(57) ABSTRACT

Manufacture of a scented authorization card applies a first portion of card data retrieved from a database to either a dimensionally stable substrate or to a scent-emanating layer. Those components are thereafter laminated together. A post-lamination step in which at least a second portion of card data is applied to the laminated authorization card completes the manufacture. The scent-emanating layer can have a fragrance substituted for a portion of a plasticizer which diffuses over time from the layer into the ambient.

This application is a continuation-in-part of co-pending application Ser. No. 11/440,251, filed May 23, 2006, which is a continuation-in-part of application Ser. No. 11/307,758, filed Feb. 21, 2006, and claims the benefit of priority under 35 USC 119(e) from U.S. provisional Application Nos. 60/692,644, filed Jun. 20, 2005, 60/705,807, filed Aug. 4, 2005, and 60/739,304, filed Nov. 23, 2005, which are hereby incorporated by reference in their respective entireties.

### FIELD OF THE INVENTION

The present invention relates to scented authorization cards, and more specifically, relates to plastic authorization cards with a fragrance embedded in the plastic.

### BACKGROUND OF THE INVENTION

Authorization cards are ubiquitous in modern society; the average person carries several and uses authorization cards many times every day.

Authorization cards, as that term is used herein, include any card that communicates information with an electronic device. Typical authorization cards include credit cards, debit cards, gift cards, smart cards, digital access keys, identification cards and consumer club cards, amongst others. Such cards are read using an electronic device in order to transmit information related to the card itself or to an account or record associated with the owner or holder of the card. The electronic device reads a machine-readable code supported by the card. Examples of machine readable codes include magnetic stripes, bar codes and devices that receive or transmit electromagnetic signals (e.g., RFID tags).

Because of the abundance of authorization cards that are available, there is a desire by both the card owners and suppliers to make the cards unique. Known methods of personalizing or differentiating authorization cards are by printing graphics on the card's outer layer, adding holographic images, pictures and the like.

Authorization cards also frequently include important information, such as the account number, embossed in the card. This ensures that this information cannot be accidentally removed and permits a mechanical transfer of the card number to a carbon-backed receipt.

Methods of manufacturing authorization cards with the foregoing features are old and well known. An exemplary method of producing an authorization card is disclosed in U.S. Pat. No. 6,644,551 to Clayman et al., which is hereby incorporated by reference. The conventional method of producing an authorization card is by laminating one or more layers to each side of a polyvinyl chloride acetate or polyvinyl chloride (PVCA or PVC) core followed by adding a magnetic stripe, graphics, stickers, embossing, printing and the like. Other substrates and lamination layers include, but are not limited to paper, polyester, etc. Some of these are described in patents: U.S. Pat. Nos. 6,769,718, 6,305,716, 6,039,356, 6,030,701, 5,863,076, 5,769,457, 5,495,981, and 4,978,146.

These methods typically operate upon card blanks that are ready to have customer specific data applied. The art is improved by providing further differentiations from known credit card constructions. The present invention addresses that need.

### SUMMARY OF THE INVENTION

The present invention is advantageous over the prior art because it provides an authorization card with an additional unique feature to those known in the art. As an improvement in the art, a scented substrate having a fragrance substituted for a portion of the plasticizer in the conventional card core, and has material characteristics enabling the construction of an authorization card having a thin plastic body which supports a machine-readable code thereon. The authorization card has two broad surfaces and an edge therebetween. The machine-readable code contains data that is readable by an electronic device. The fragrance embedded within the plastic body is perceptible to a user and adds uniqueness to the card. The embedded fragrance lasts a considerable length of time.

Alternatively, the core of the card is made of a cellulosic material instead of a conventional core (polyvinyl chloride or polyvinyl chloride acetate) and fragrance is substituted for a portion of the plasticizer. A card with a cellulosic core can offer the consumer a card with a translucent appearance (the card can have a monolithic structure) and provides a better carrier for the fragrance.

In another aspect, a laminated card construction combines a substrate having the feature of dimensional stability with a scented layer as described above. Such a card is manufacturable by printing card data on one or more card layers prior to card lamination and prior to any embossing or other post-lamination step. As such, the manufacturing process departs from convention approaches by using portions of card data suitable a particular card both before and after the authorization card has been laminated.

A laminated card according to this aspect of the invention can be manufactured by the steps of providing a substrate having dimensional stability, retrieving card data from a database, applying at least a first portion of the card data to the substrate, laminating a scent-emanating layer to the substrate layer after the applying step, and performing at least one post-lamination step by which at least a second portion of the card data is applied to the laminated authorization card.

Similarly, a laminated card according to this aspect of the invention can be manufactured by the steps of providing a scent-emanating layer, retrieving card data from a database, applying at least a first portion of the card data directly to the scent-emanating layer, laminating the scent-emanating layer to a dimensionally-stable substrate after the applying step, and performing at least one post-lamination step by which at least a second portion of the card data is applied to the laminated authorization card.

These and other aspects, features and advantages of the present invention will be appreciated from the following written description and accompanying drawing figures.

### BRIEF DESCRIPTION OF THE DRAWINGS

FIG. 1. is a front view of an authorization card in accordance with the invention;

FIG. 2 is a side view of the authorization card of FIG. 1;

FIG. 3 is a back view of the authorization card of FIG. 1;

FIG. 4 is an exemplary process flow for fabricating a scented laminated card in accordance with certain aspects of the invention;

FIG. 5 is a side view of an authorization card manufactured in accordance with the process of FIG. 4, shown with the substrate and scented layers partially broken-away;

FIG. 6A is a top plan view of a core or substrate layer of the authorization card of FIG. 5; and

FIG. 6B is a bottom plan view of a scented layer for the authorization card of FIG. 5.

### DETAILED DESCRIPTION OF THE PREFERRED EMBODIMENT

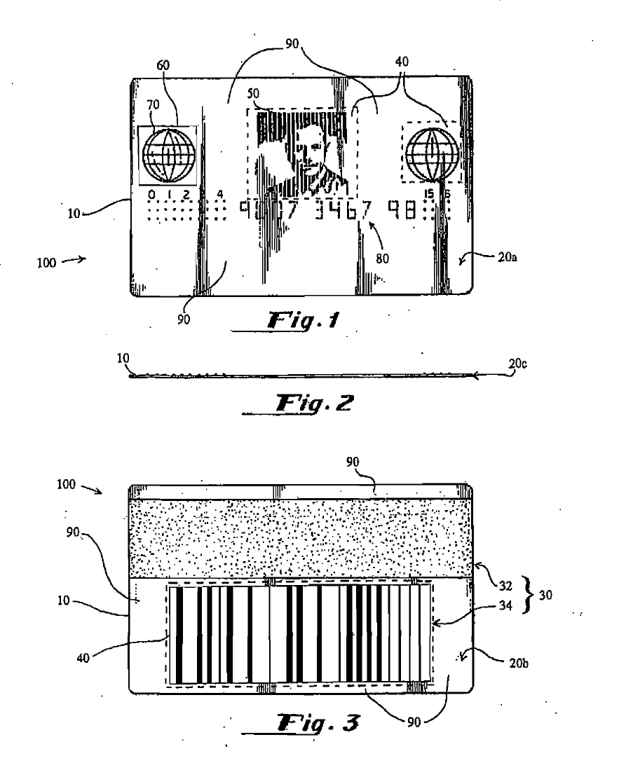

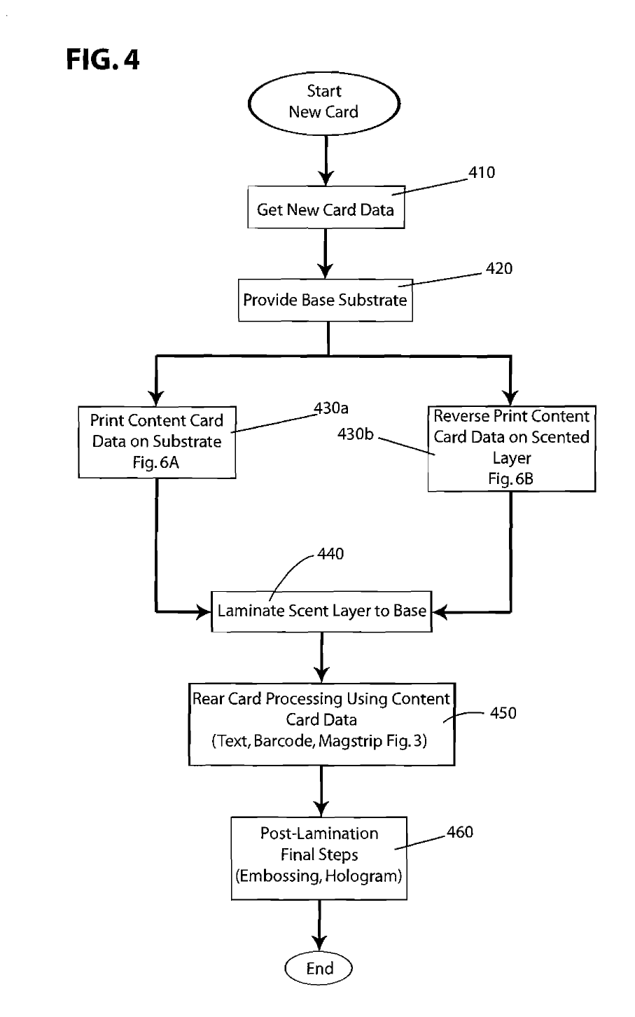

An exemplary embodiment of the authorization card 100 of the claimed invention is shown in FIGS. 1-3. The card 100 includes a thin plastic body 10 having a first broad surface 20a and a second broad surface 20b with a thin edge 20c therebetween. The card is preferably rectangular with rounded corners. However, any two dimensional shape could be used as an authorization card so long as it satisfies industry standards for machine-readability. The thin plastic body 10 is preferably a monolithic substrate which differs from conventional PVC and PVCA cards in having a cellulosic substrate with a fragrance substituted for a portion of the plasticizer such that the fragrance is embedded therein. More preferably, the plastic body comprises a fragrance-embedded cellulose acetate propionate. The term “cellulosic” refers to cellulose acetates and cellulose acetate esters and includes, but is not limited to, cellulose acetate, cellulose acetate propionate, and cellulose acetate butyrate. Cellulose acetate esters include, but are not limited to, cellulose diacetate and cellulose triacetates. The term “cellulosic” also includes all hydrates of cellulosics (e.g. anhydrous cellulose acetate, cellulose acetate monohydrate, cellulose acetate dihydrate, cellulose acetate trihydrate, and cellulose acetate tetrahydrate) as well as anhydrous forms of cellulosics. Techniques for introducing fragrance into cellulosics are described in co-pending U.S. Application Ser. Nos. 60/739,304, filed Nov. 23, 2005, 60/705,807, filed Aug. 4, 2005 and 60/692,644, filed Jun. 20, 2005, the entireties of each said application being hereby incorporated by reference.

Authorization card 100 includes one or more machine readable codes 30, such as magnetic stripe 32 or bar code 34. The machine readable code 30 contains data that an electronic device reads. The data identifies authorization card 100 to the electronic device. Unlike PVC and PVCA cores used for conventional authorization cards, the plastic body 10 of the authorization card 100 can have considerable translucency up to complete transparency when constructed of a cellulosic, and can include a dye or the like to provide the plastic body 10 with a color, if desired.

The authorization card 100 has printed indicia disposed on a portion of its broad surfaces 20a, 20b. The card 100 optionally has a primer 40 to enable an image 50 and any other printing to print clearly and not wear off easily. There are many different printing methods that can be used. The preferred method is digital printing without the use of a primer layer. Such printing technique prints in a dithered pattern of ink dots to impart images and characters to the broad surface of the card while simultaneously preserving unprinted real estate on the card surface for fragrance emission. There remain large amounts of unprinted areas between the dots that allow for fragrance migration into the ambient. Barcodes, when provided, can be printed onto the cards, and need not be provided on a laminate. A laminate section 60 can be joined to the first broad surface 20a by glue or heat lamination to provide, for example, a hologram, magnetic stripe or smart card/RFID feature to the card 100. Thus, the machine-readable code 30 can be disposed in the laminate section 60, in certain constructions that are in accordance with the present invention. An embossed portion 80 also can be provided in the plastic card 10.

The illustrated embodiment is free of any laminate or covering layer on broad surfaces 20a, 20b. Consequently, the optical properties of the core of the plastic card 10 are visible to the user and not sandwiched in a laminate structure. In a preferred embodiment, the core of the card is a translucent cellulosic material and does not contain (that is, the card is free of any) polyvinyl chloride or polyvinyl chloride acetate or polyester. Further, regions 90 are exposed to the environment to permit unimpeded diffusion of the fragrance from the plastic body 10 into the ambient. Thus the regions 90 freely breath and thereby impart the fragrance to the environment. To further promote permeation of the fragrance into the air, one or more of the exposed regions 90 can have a matted finish (not shown for clarity of the drawings) which increases the surface area of the exposed regions 90, thereby increasing the communication between the plastic body 10 and the ambient.

In a preferred construction, the regions 90 on the first and second broad surfaces 20a, 20b are arranged to be distributed about the plane of the card 10 so that evaporation of fragrance is even across the card surface. This arrangement minimizes any warping that might occur in a coreless construction after some of the (non-laminated) fragrance has evaporated.

Alternatively, the authorization card 100 can include a laminate on a substantial portion of one or more surfaces of the thin plastic body 10. The laminate can impart dimensional stability to the card, but is preferably arranged to not substantially impede permeation of the fragrance into the ambient. Alternatively, there may be a full surface lamination on either side 20a or 20b, but in this configuration the fragrance will only emit from the opposite surface and the edges 20c.

Referring now to FIGS. 4-6, a fabrication process for making laminated scented cards and a laminated scented card 200 are described in furtherance of additional aspects of the present invention.

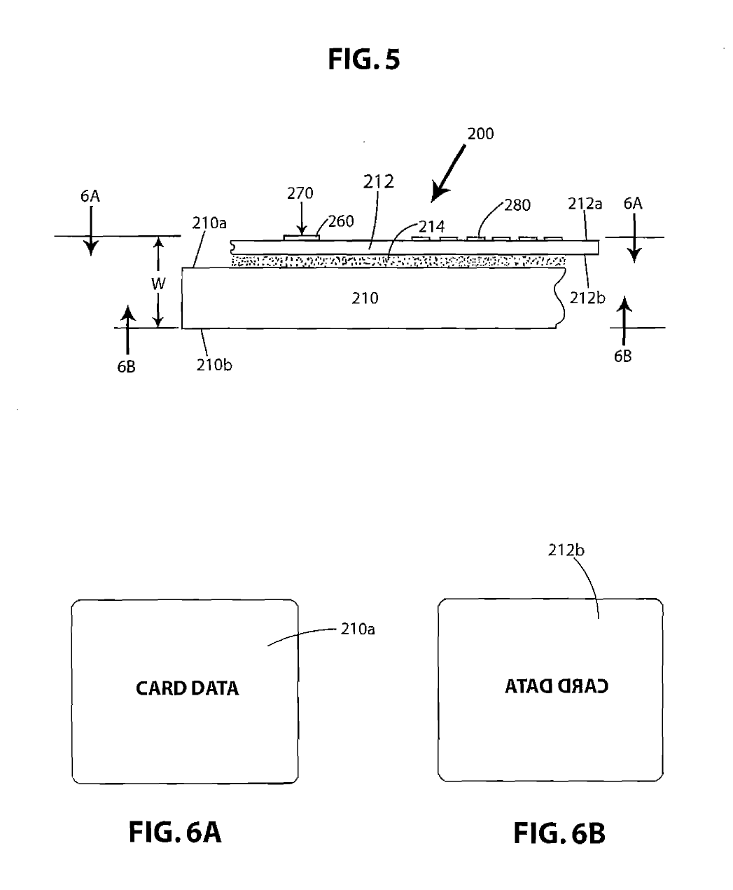

A scented card 200 as shown in FIG. 5 can comprise a conventional substrate 210 as a support for a scented layer 212. The base substrate 210 provides a rigid platform for the scented layer so as to substantially preclude any warping over time due to evaporation of fragrance from the scented layer 212. The substrate can comprise a stock of PVC, PVCA, polyester or polystyrene, which are equally preferred based materials as they are all dimensionally stable (that is, they exhibit insubstantial warping).

The scented layer 212 preferably comprises a cellulosic substrate having a fragrance substituted for a portion of the plasticizer, and can be any of the materials described above. The scented layer can have a thickness from about 1 mil to about 11 mil, and more preferably from about 2 mil to about 10 mil, with the width W of that scented layer and substrate together being no more than 30 mil to ensure compatibility with conventional card readers, and preferably less than 30 mil to allow for embossing and other post-lamination steps.

The scented layer 212 is laminated, adhered, or pressed onto the substrate. For example, an adhesive 214 can be interposed between the substrate and the scented layer. Preferably, the scented layer 212 and any adhesive 214 are clear or transparent to allow for visible inspection of the abutting (top) surface 210A of the substrate. Optionally, a heating or UV curing step is used to permanently secure the scented layer to the substrate.

In FIG. 5, a portion of the scented layer 212 and adhesive 214 are broken away to expose the top surface 210A of the substrate 210, and a portion of the substrate has been broken away to show the bottom surface 212B of the scented layer. In a finished card 200, the substrate and scented layers can be co-terminus with one another about a periphery of the card.

The card 200 can be constructed by the process of FIG. 4. A new card 200 is created by modifying a conventional card fabrication process to perform some steps before lamination of the scented layer as the top layer and other steps after lamination of the scented layer. Thus, new card data is retrieved at step 410, and can include information such as a card holder's name, account number, room number or credit limit, expiration date and other information typically encoded or included on an authorization card. For example, the card data can be obtained from a database. A substrate 210 is provided at step 420 for supporting the card data. Specifically, the card data can be combined with the substrate 210 by printing at least a portion of the card data in a conventional manner (and using conventional ink) on the top surface 210A of the substrate, as indicated at step 430A. The card data is printed for direct viewing, as shown in FIG. 6A. Alternatively or in addition, at least a portion of the card data can be reverse printed onto a rear (under) surface 212B of the scented layer 212, as shown in FIG. 6B and indicated at step 430B.

At step 440, the scented layer 212 is laminated or otherwise adhered to the substrate 210, after the printing step 430A, 430B, to define a card construction having a total width W of no more than about 30 mil. Either the substrate or the scented layer can have polished or matted surfaces if desired. A matted surface 210A or 212B, for example, can promote adhesion and a matted surface 212A can increase the surface area of the exposed portion of the scented layer 212 to promote diffusion of fragrance into the environment.

At step 450, rear card processing steps can be performed using the same card data utilized in the printing steps 430A, 430B. The rear-card processing can include printing of text or barcodes, magnetic stripe application, near field communication (“NFC”) device or RFID tag embedding, and so on onto or into the rear (outer) surface 210B of the substrate 210. It should be understood that step 450 can be performed prior to step 430 and 440, if desired.

At step 460, post-lamination steps can be performed. For example, a portion of the card data can be embossed into the card 200 to provide embossing 280, a hologram 270 can be applied, with or without a lamination section 260, or each of the steps can be performed.

It should be appreciated that features of one embodiment or arrangement can be included in any other embodiment or arrangement without departing from the present disclosure, and although embodiments of the invention has been shown and described, many features may be varied, as will readily be apparent to those skilled in this art. It is the intention, therefore, to be limited only as indicated by the scope of the claims appended hereto and equivalents of the recitations in such claims.

We claim:

1. A method for manufacturing an authorization card, comprising the steps of.
providing a substrate having dimensional stability, the substrate having a top surface and a rear surface;
retrieving card data from a database,
applying at least a first portion of the card data to the top surface of the substrate;
laminating a scent-emanating layer to the top surface of the substrate layer after the applying step; and
performing at least one post-lamination step by which at least a second portion of the card data is applied to the laminated authorization card.

2. The method of claim 1, wherein the post lamination step comprises embossing at least the second portion of the card data on the laminated authorization card.

3. The method of claim 1, wherein the post lamination step comprises applying at least the second portion of the card data directly upon the rear surface of the substrate.

4. The method of claim 3, wherein the post-lamination applying step comprises applying a bar code, a magnetic stripe, printed text, or a combination of the foregoing directly upon the rear surface of the substrate.

5. The method of claim 1, wherein the post lamination step comprises embedding a transponder into the laminated authorization card, the transponder communicating at least the second portion of the card data.

6. The method of claim 5, wherein the transponder is an RFID tag, a NFC device, or both.

7. The method of claim 1, method including the additional steps of fabricating the scent-emanating layer by mixing either a cellulose acetate, a cellulose acetate propionate, or a cellulose acetate butyrate with a fragrance and a plasticizer, wherein a concentration of fragrance is substituted for a portion of the plasticizer in the scent-emanating layer.

8. The method of claim 1, wherein the applying step comprises printing at least the first portion of the card data directly upon the top surface of the substrate.

9. The method of claim 1, including the additional step of laminating a hologram directly upon the scent-emanating layer.

10. The authorization card of claim 1, including the additional step of matt-finishing the scent-emanating layer.

11. A method for manufacturing an authorization card, comprising the steps of:
providing a scent-emanating layer having a bottom surface;
retrieving card data from a database,
applying at least a first portion of the card data directly to the bottom surface of the scent-emanating layer;
after the applying step, laminating the bottom surface of the scent-emanating layer to a top surface of a substrate, the substrate providing dimensional stability to the authorization card; and
performing at least one post-lamination step by which at least a second portion of the card data is applied to the laminated authorization card.

12. The method of claim 11, wherein the post lamination step comprises embossing at least the second portion of the card data on the laminated authorization card.

13. The method of claim 11, wherein the substrate has a rear surface and wherein the post lamination step comprises applying at least the second portion of the card data directly upon the rear surface of the substrate.

14. The method of claim 13, wherein the post-lamination applying step comprises applying a bar code, a magnetic stripe, printed text, or a combination of the foregoing directly upon the rear surface of the substrate.

15. The method of claim 11, wherein the post lamination step comprises embedding a transponder into the laminated authorization card, the transponder communicating at least the second portion of the card data.

16. The method of claim 15, wherein the transponder is an RFID tag, a NFC device, or both.

17. The method of claim 11, method including the additional steps of fabricating the scent-emanating layer by mixing either a cellulose acetate, a cellulose acetate propionate, or a cellulose acetate butyrate with a fragrance and a plasticizer, wherein a concentration of fragrance is substituted for a portion of the plasticizer in the scent-emanating layer.

18. The method of claim 11, wherein the applying step comprises reverse printing at least the first portion of the card data directly upon the bottom surface of the scent-emanating layer.

19. The method of claim 11, including the additional step of laminating a hologram directly upon the scent-emanating layer.

20. The authorization card of claim 11, including the additional step of matt-finishing the scent-emanating layer.
